(19) United States
(12) Patent Application Publication
(10) Pub. No.: US 2022/0292812 A1
(43) Pub. Date: Sep. 15, 2022

(54) ZERO-SHOT DYNAMIC EMBEDDINGS FOR PHOTO SEARCH

(71) Applicant: GUANGDONG OPPO MOBILE TELECOMMUNICATIONS CORP., LTD., Dongguan (CN)

(72) Inventors: Jenhao Hsiao, Palo Alto, CA (US); Yikang Li, Palo Alto, CA (US)

(21) Appl. No.: 17/831,423

(22) Filed: Jun. 2, 2022

Related U.S. Application Data
(63) Continuation of application No. PCT/CN2020/131126, filed on Nov. 24, 2020.
(60) Provisional application No. 62/945,454, filed on Dec. 9, 2019.

(51) Int. Cl. G06V 10/764; G06F 16/56; G06F 16/51; G06F 16/35

(52) U.S. Cl. CPC G06V 10/764; G06F 16/56; G06F 16/51; G06F 16/353

(57) ABSTRACT

One example of a method of indexing a plurality of images includes, for each of the plurality of images, generating a feature vector for the image, applying a trained set of classifiers to the feature vector to generate a score vector for the image, and, based on the score vector and a set of category word vectors, producing a variable number of semantic embedding vectors for the image.

### CROSS-REFERENCE TO RELATED APPLICATION(S)

This application is a continuation of International Application No. PCT/CN2020/131126, filed Nov. 24, 2020, which claims priority to U.S. Provisional Patent Application No. 62/945,454, field Dec. 9, 2019, the entire disclosures of both of which are hereby incorporated by reference.

### BACKGROUND

This disclosure relates to indexing, classification, and query-based retrieval of photographs.

### SUMMARY

A method of indexing a plurality of images comprises, for each of the plurality of images, generating a feature vector for the image, applying a trained set of classifiers to the feature vector to generate a score vector for the image, and, based on the score vector and a set of category word vectors, producing a variable number of semantic embedding vectors for the image.

A computer-readable storage medium comprising code which, when executed by at least one processor, causes the at least one processor to perform such a method is also disclosed.

An image indexing system comprises a trained neural network configured to generate a feature vector for an image to be indexed, a predictor configured to apply a trained set of classifiers to the feature vector to generate a score vector for the image, and an indexer configured to produce a variable number of semantic embedding vectors for the image, based on the score vector and a set of category word vectors.

### BRIEF DESCRIPTION OF DRAWINGS

Various embodiments in accordance with the present disclosure will be described with reference to the drawings, in which like reference numbers indicate similar elements, and in which:

FIG. 1A shows a block diagram of an image indexing system XS100 according to a general configuration.

FIG. 1B shows a block diagram of a process for generating a word vector space.

FIG. 2 shows a block diagram of an implementation XS110 of indexing system XS 100.

FIG. 3 shows a block diagram of a training system TS100 according to a general configuration.

FIG. 4 illustrates a portion of a matrix multiplication operation.

FIG. 5 shows a block diagram of an implementation TS110 of training system TS100.

FIG. 6 shows a block diagram of an implementation TS120 of training system TS100.

FIG. 7 shows a flowchart of an image indexing method XM100 according to a general configuration.

FIG. 8 shows a flowchart for a query searching method SM100 according to a general configuration.

FIG. 9 shows a block diagram of a computer system 1400.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The current state of photo album design is not adequate for handling the large volume of photographs taken by a typical user with a smartphone camera. For example, the massive amount of photographs in a typical album makes it challenging to scroll backward in time to find photographs taken a few days ago, let alone months or years ago. With the ever-growing supply of image photographs, from an ever-expanding number of classes, there is an increasing need to use prior knowledge to perform image searching based on semantic relationships between seen and unseen classes. An image search engine that can help users efficiently retrieve related photographs by keywords becomes essential.

One approach to text-image searching is based on a deep feature vector as generated by a deep convolutional neural network (CNN), where the CNN has been trained with a softmax output layer that has as many units as the number of classes. This approach breaks down as the number of classes grows, however, because the distinction between classes tends to blur, and it becomes increasingly difficult to obtain a sufficient number of training images to distinguish rare concepts.

Another approach to text-image searching is based on image classification results. The performance of image classification has progressed rapidly, due to the establishment of large-scale hand-labeled datasets (such as ImageNet, MSCOCO, and PASCAL VOC) and the fast development of deep convolutional networks (such as VGG, InceptionNet, ResNet, etc.), and many efforts have been dedicated to extending deep convolutional networks for single/multi-label image recognition. For a photo-searching application, such an approach may use pre-defined categories as the indexed tags to build a search engine. For example, such an approach may directly use a set of labels, predicted by a trained classifier, as the indexed keywords for each photo. During a search stage, such a system performs exact-keyword-matching between the user's query and the category names to retrieve photos having the same label name as the user's query. It may be seen that this type of search is more like a keyword filtering mechanism than an actual search function, since the system can only accept predefined keywords and can only retrieve photos that have the exact same category name as the user's search term.

A text-based photo retrieval task may rely on encoding an image into only a single embedding vector, and trying to map this vector into a joint visual-text subspace. Such a method often fails and gives poor retrieval accuracy, since an image usually contains complex scenes and multiple concepts. Using only a single vector to encode multiple concepts of an image tends to over-compress the information and degrade the feature quality.

The range of embodiments described herein includes systems, methods, and devices that may be used to retrieve the photos in a personal photo album that are determined to correspond best to a given query keyword. Such an embodiment may include a finer-grained end-to-end network to tackle the aforementioned problems than previously used in photo search systems. A zero-shot learning strategy may be adopted to map an image into a semantic space so that the resulting system has the ability to correctly recognize images of previously unseen object categories via semantic links in the space. While zero-shot learning has been described as a regression problem from the input space to the semantic label embedding space, this disclosure includes embodiments that do not explicitly learn a regression function f:X→S but instead use a trained set of multi-label classifiers to generate multiple semantic embeddings for each image being indexed.

As compared to an approach that may compress all the complex scene information in an image into a single vector, methods are proposed herein which can dynamically generate a variable number of embedding vectors, based on the image content, to better retain complex object and scene information that may be present in an image. Methods are also proposed herein that use a multi-label graph convolution model to effectively capture correlations between object labels (e.g., as indicated by a co-occurrence of objects in an image), which may greatly boost image recognition accuracy. In this disclosure, we present a novel method for dynamically constructing multiple embeddings (also called “mixture embedding”) for an image by combining a probabilistic n-way image multi-label classifier with an existing word embedding model that contains the n class labels in its vocabulary.

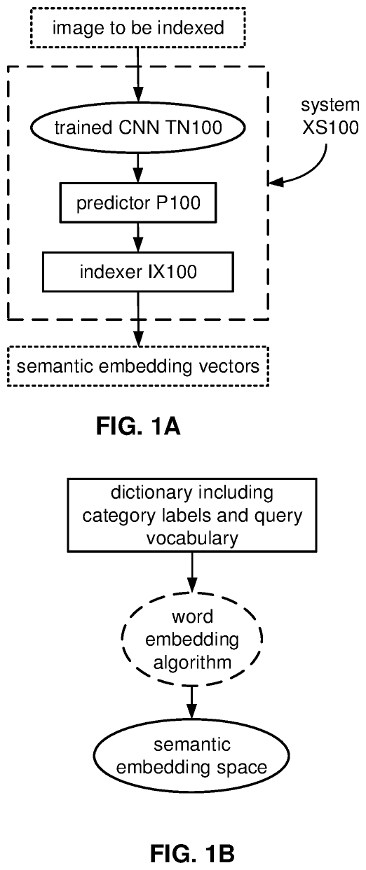

FIG. 1A shows a block diagram of an image indexing system XS100 according to a general configuration that includes a trained CNN TN100, a predictor P100, and an indexer IX100. Trained CNN TN100 is configured to receive an image to be indexed and to generate a corresponding feature vector. Predictor P100 is configured to apply a trained set of classifiers to the feature vector to generate a score vector for the image. Indexer IX100 is configured to produce a variable number of semantic embedding vectors for the image, based on the score vector. In this context, the term “variable number” indicates a number whose value is not predetermined but is based instead on a relation between a set of categories and the content of the particular image (e.g., as indicated by the score vector), and the value of the variable number is likely to change from image to image.

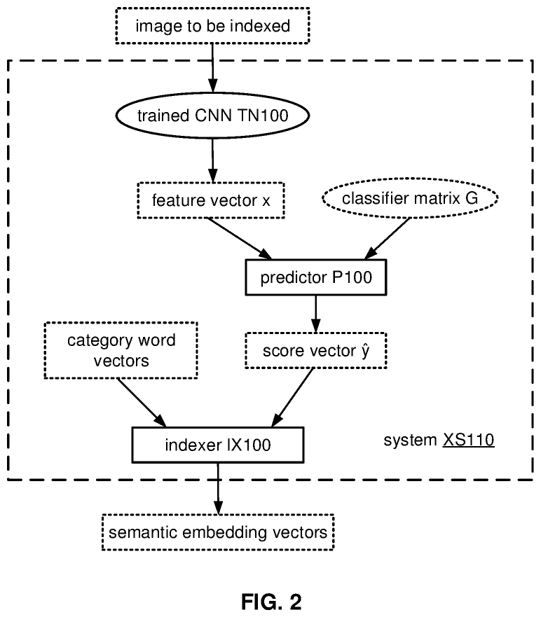

FIG. 2 shows a block diagram of an implementation XS110 of indexing system XS100. In this implementation, trained CNN TN100 is configured to generate a feature vector (denoted as x) of dimension d, and predictor P100 is configured to apply a filter matrix (denoted as G) of dimension C×d to feature vector x to generate a score vector (denoted as ST) of dimension C. In this implementation, indexer IX100 is configured to select a variable number of word vectors for the image, based on the score vector. In one example, each of the selected word vectors corresponds to one of the C categories and to a corresponding element of the score vector, and each of the semantic embedding vectors is based on a corresponding one of the selected word vectors.

Each of the C categories is associated with a unique identifying word or phrase, also called a “label.” Examples of the labels of the C categories may include objects, such as ‘dog,’ ‘bird,’ ‘child,’ ‘ball,’ ‘building,’ ‘cloud,’ ‘car,’ ‘food,’ ‘tree,’ etc. The C categories may include only objects (as in these examples), or the C categories may also include non-object descriptors such as locations (e.g., ‘city,’ ‘beach,’ ‘farm,’ ‘New York’), actions (e.g., ‘run,’ ‘fly,’ ‘eat,’ ‘reach’), etc. The number of categories C is typically at least twenty and may be as large as one hundred or even one thousand or more.

As disclosed above, the semantic embedding vectors may be based on corresponding category word vectors, which are now described in more detail with reference to FIG. 1B. FIG. 1B shows a block diagram of a process for generating a word vector space, also called a “semantic embedding space.” The input to this process is a text corpus whose vocabulary includes the labels of each of the C categories and also all of the entries in a desired query vocabulary. Each entry in the query vocabulary is the set of words (and possibly phrases) to be supported as possible search queries for the indexed images. In one example, the text corpus includes a dictionary definition for each of the C labels and for each entry in the query vocabulary.

The semantic embedding space may be constructed offline by inputting the text corpus into a word embedding algorithm, such as word2vec, GloVe (Global Vectors), or Gensim (RaRe Technologies, CZ). The resulting vector space includes a corresponding word vector for each of the C categories and for each of the entries in the query vocabulary. In this disclosure, it is assumed (for convenience and without limitation) that the semantic embedding space is d-dimensional and that the set of category word vectors (denoted as Z) is implemented as a matrix of size C×d. The dimension d of the semantic embedding space is typically at least ten, more typically at least one hundred (e.g., in the range of from three hundred to four or five hundred) and may be as large as one thousand or even more.

A multi-label recognition problem may be addressed naively by treating the categories in isolation: for example, by converting the multi-label problem into a set of binary classification problems that predict whether each category is present or not. The success of single-label image classification achieved by deep CNNs has greatly improved the performance of such binary solutions. However, these methods are essentially limited by ignoring the complex topology structure between the categories.

For multi-label image recognition, it may be desirable instead to effectively capture correlations among category labels and to use these correlations to improve classification performance. One flexible way to capture the topological structure in the label space is to use a graph to model interdependencies among the labels. System XS100 may be implemented, for example, to represent each node of a graph as a word embedding of a corresponding label and to use GCN GN100 to directly map these label embeddings into a set of inter-dependent classifiers, which can be directly applied to an image feature for classification. As the embedding-to-classifier mapping parameters are shared across all classes, the learned classifiers can retain the weak semantic structures in the word embedding space, where semantically related concepts are close to each other. Meanwhile, the gradients of all classifiers can impact the classifier generation function, which implicitly models the label dependencies.

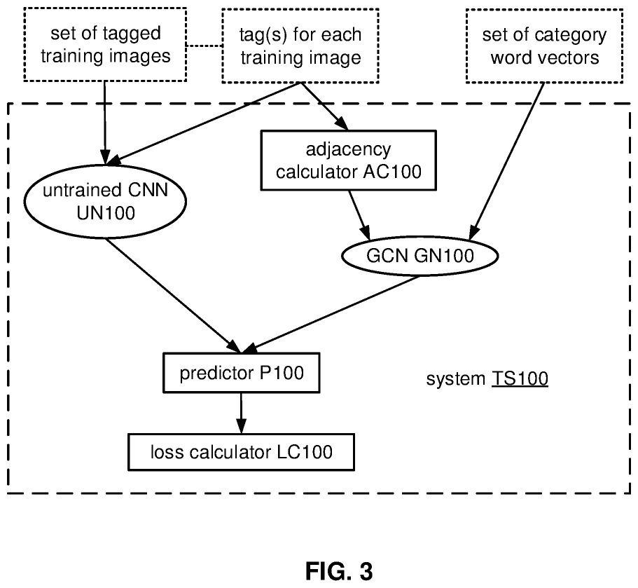

As disclosed above with reference to FIG. 1A, trained CNN TN100 is configured to generate a corresponding feature vector for the image being indexed, and predictor P100 is configured to apply a trained set of classifiers to the feature vector to generate a score vector for the image. The training of CNN TN100 and the generation of the trained set of classifiers are now described in more detail with reference to FIG. 3.

FIG. 3 shows a block diagram of a training system TS100 according to a general configuration that includes an untrained CNN UN100 configured to be trained into the trained CNN TN100, an adjacency calculator AC100, a graph convolutional network (GCN) GN100 configured to produce the trained set of classifiers, an instance of predictor P100, and a loss calculator LC100. Training system TS100 is configured to receive as input a set of tagged training images and the tag or tags for each of the training images. System TS100 is also configured to receive the set of category word vectors from the semantic embedding space.

The number of images in the training set is typically more than one thousand and may be as large as one million or more, and each of the images in the training set is tagged with at least one, and as many as five or more, of the C categories. In the following description, it is assumed (for convenience and without limitation) that the tag or tags for each training image are implemented as a binary vector of length C, where the value of each element of the tag vector indicates whether the label of the corresponding category (e.g., ‘dog,’‘bird’, etc.) appears in the image. Examples of available sets of tagged training images include ImageNet (www.image-net.org), Open Images (storage.googleapis.com/openimages/web), and Microsoft Common Objects in Context (MS-COCO) (cocodataset.org).

Untrained CNN UN100 is configured to receive training images and to generate, for each training image, a corresponding feature vector of dimension d. CNN UN100 may be implemented using any CNN base model configured to learn the features of an image and generate such a feature vector. In one example, CNN UN100 is implemented using ResNet as the base model. In this case, for an input image I of resolution 448×448, a set of 2048×14×14 feature maps may be obtained from the “conv5 x” layer of the CNN. A global pooling operation (e.g., global max-pooling or global average pooling) may then be applied to the feature maps to obtain the corresponding image-level feature vector x∈ [symbol] ^{D} (in this particular example, D=2048).

System TS100 is operated to train CNN UN100 to generate image-level feature vectors and to use adjacency calculator AC100 and GCN GN100 to produce the trained set of classifiers. Adjacency calculator AC100 is configured to calculate an adjacency matrix that represents interdependencies among the category labels, based on the label tags from the training set of images. GCN GN100 is configured to use the adjacency matrix and the set of category word vectors to construct the trained set of classifiers. For example, GCN GN100 may be configured to perform a graph convolution algorithm on a graph that is represented by the set of category word vectors (the nodes of the graph) and the adjacency matrix (the edges of the graph).

In one example, calculator AC100 is implemented to model the label correlation dependency by a conditional probability, such as P(Lⱼ|Lᵢ), which denotes the probability of occurrence of label Lⱼ given the occurrence of label Lᵢ. Such an implementation of adjacency calculator AC100 may be configured to use the tags of the training images to calculate a correlation or co-occurrence matrix M of dimension C×C, in which each element Mᵢⱼ denotes the number of images that are tagged with label Lᵢ and label Lⱼ together. The label co-occurrence matrix M may be used to calculate a conditional probability matrix A of dimension C×C by an operation such as Aᵢⱼ=Mᵢⱼ/Nᵢ, where Nᵢ denotes the number of images in the training set that are tagged with label Lᵢ, and Aᵢⱼ=P(Lⱼ|Lᵢ).

A GCN-based mapping function may be used to learn a set of inter-dependent label classifiers from the label representations. For example, GCN GN100 may be configured to use the set Z of category word vectors and the adjacency matrix A to construct a trained set of C d-dimensional classifiers (G), each classifier corresponding to one of the C categories. In the following description, it is assumed (for convenience and without limitation) that the trained set of classifiers G is implemented as a matrix of size C×d. In one example, GCN GN100 is configured to perform a graph convolution algorithm that obtains the trained set of classifiers by performing zero-shot learning on a graph that is represented by set Z (the nodes of the graph) and matrix A (the edges of the graph).

GCN GN100 may be implemented as a stacked GCN, such that each GCN layer takes the node representations from the previous layer as input and outputs new node representations. For example, the graph convolution algorithm performed by GCN GN100 may be configured to learn a function f(·,·) on a graph G by taking feature descriptions Hₗ∈ [symbol] ^{n×d} and the corresponding correlation matrix A∈ [symbol] ^{n×n} as inputs (where n denotes the number of nodes and d indicates the dimensionality of the label-level word embedding) and updating the node features as H^{l+1}∈ [symbol] ^{n×d′} (where d′ may differ from d). Each layer l of GCN GN100 may be written as a non-linear function by H^{l+1}=f(H^{l}, A). After employing the convolutional operation, f(·,·) can be represented as H^{l+1}∈h(AH^{l}W^{l}), where W^{l}∈ [symbol] ^{d×d′} is a transformation matrix to be learned, A∈ [symbol] ^{n×n} is a normalized version of correlation matrix A, and h(·) denotes a non-linear operation (e.g., a rectified linear unit (ReLU), leaky ReLU, sigmoid, or tanh function). For the last layer, the output may be described as G∈ [symbol] ^{C×D}, with D denoting the dimensionality of the image-level feature vector x as produced by untrained CNN UN100 or trained CNN TN100.

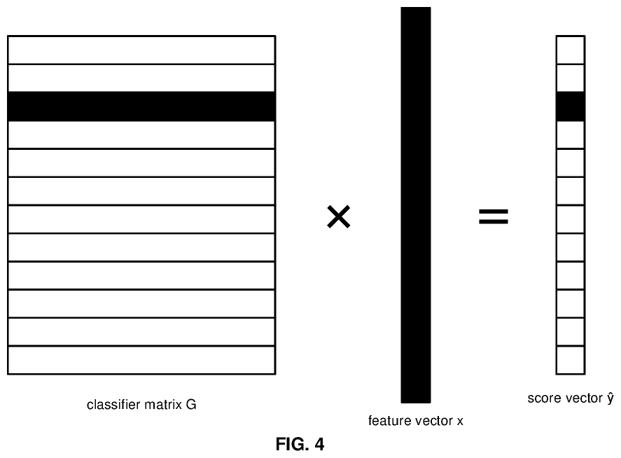

Predictor P100 may be configured to use the trained set of classifiers G to weight the feature vector x, producing a label probability vector (“score vector”) ŷ of length C in which each element indicates a likelihood that the image is associated with the corresponding label. In one such example, predictor P100 is implemented to generate a score vector by performing a matrix multiplication Gx=ŷ (e.g., as shown in FIG. 4), where x is the image-level feature vector as described above. In this example, matrix G has the dimensions C×d, and each row of matrix G is a trained classifier that corresponds to one of the C categories. Likewise, score vector ŷ has length C, with each element corresponding to one of the C categories in the same order. For each category i, such an implementation of predictor P100 calculates a corresponding score ŷᵢ for the image being indexed as the dot product of row i of matrix G with feature vector x, the resulting score being stored to the i-th element of score vector ŷ.

The ground truth label of an image may be represented as y∈ [symbol] ^{C}, where yᵢ={0, 1} denotes whether label i appears in the image or not. The tag vectors of the training images are used as ground-truth vectors y to guide the training of CNN UN100, and the whole network may be trained using a traditional multi-label classification loss as calculated by loss calculator LC100, such as the following loss function L:

L=Σ_{c=1}^{C}y_{c}log(σ(ŷ_{c}))+(1−y_{c})log(1−σ(ŷ_{c})),

where σ(·) is the sigmoid function.

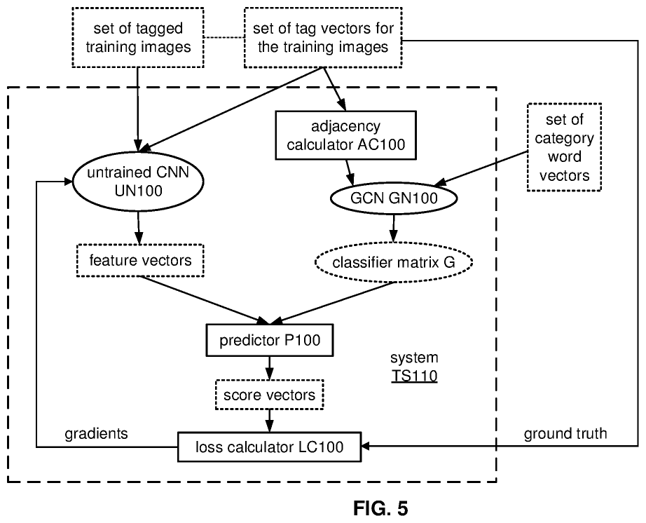

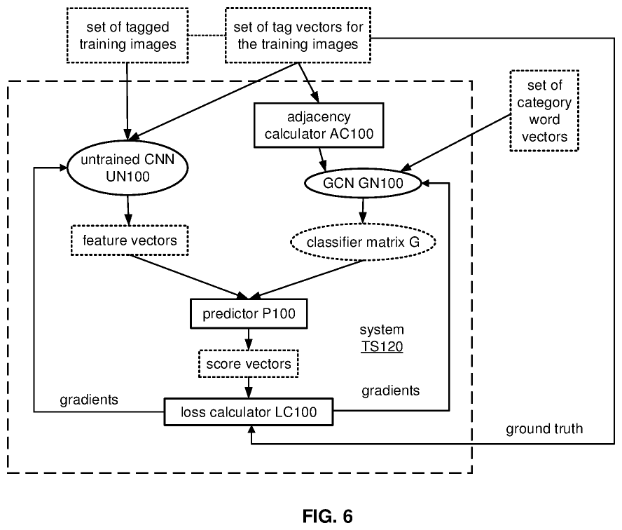

FIG. 5 shows a block diagram of an implementation TS110 of training system TS100 in which GCN GN100 is trained first to produce a trained set of classifiers G, and the trained set of classifiers is then used to train CNN UN100 on the set of training images to produce trained CNN TN100 (e.g., such that the d-dimensional feature vectors corresponding to the training images minimize the result of the loss function as calculated by loss calculator LC100). In another example, training system TS100 may be implemented such that CNN UN100 is trained first to produce trained CNN TN100 to produce a feature vector for a corresponding input image, and trained CNN TN100 is then used to train GCN GN100 (e.g., to minimize the result of the loss function as calculated by loss calculator LC100) to produce the set of trained classifiers. FIG. 6 shows a block diagram of another implementation TS120 of training system TS100 in which CNN UN100 and GCN GN100 are trained at the same time to produce trained CNN TN100 and the trained set of classifiers (e.g., to minimize the result of the loss function as calculated by loss calculator LC100) by passing back gradients during backpropagation.

In system XS100, predictor P100 may be configured to produce predicted scores ŷ by applying the trained set of classifiers to image representations as ŷ=Gx, where x is the image-level feature vector as described above. Each element ŷᵢ of score vector ŷ indicates a probability that the image being indexed is within the class represented by the corresponding category i (e.g., a probability that the image contains the object i). Indexer IX100 is configured to produce, for the image, a variable number of vectors of a semantic embedding space, based on the score vector and a set of category word vectors. Each of the variable numbers of vectors for the image corresponds to one of the C categories and to a corresponding element of the score vector.

Indexer IX100 may be configured to use the top T predictions of ŷ for an input image I to deterministically predict an embedding for the image as a set of T semantic embedding vectors emb(I)∈ [symbol] ^{T×D} In one such example, the variable number of vectors (T) is the number of elements of score vector ŷ (“confidence scores”) whose values are not less than (alternatively, are greater than) a threshold value (e.g., 0.5). Indexer IX100 may be configured to produce an embedding for the image as the set of word vectors for the categories that correspond to each such element ŷᵢ. In another example, indexer IX100 may be configured to produce an embedding for the image as the set of word vectors for the categories that correspond to each such element ŷᵢ, with each of the word vectors being weighted by the value of the corresponding element ŷᵢ. In such case, the embedding emb(I) can be considered as the convex combination of the semantic embeddings of the category labels (i.e., the d-dimensional category word vectors) weighted by their corresponding probabilities ŷᵢ. Such an embedding may be described as emb(I)={emb(I)₁, emb(I)₂, . . . emb(I)_{T}}, where emb(I)ᵢ=ŷᵢ×s(labelᵢ), and s(·) indicates the word-to-vector transformation function that transforms a category label or query term into a d-dimensional vector of the semantic embedding space.

Indexer IX100 may be implemented such that if a classifier is very confident in its prediction of a label for an image, then the corresponding category word vector may be directly adopted as one of the embedding vectors for the image without any modification (e.g., if ŷ_{dog}≈1, then emb_{dog}(I)=s(‘dog’)), and if the classifier has doubts in a prediction (e.g., as to whether an image contains a certain object), then the corresponding semantic embedding vector is down-weighted to reflect this uncertainty in the semantic space (e.g., if ŷₗᵢₒₙ=0.4, then embₗᵢₒₙ(I)=0.4×s(‘lion’)).

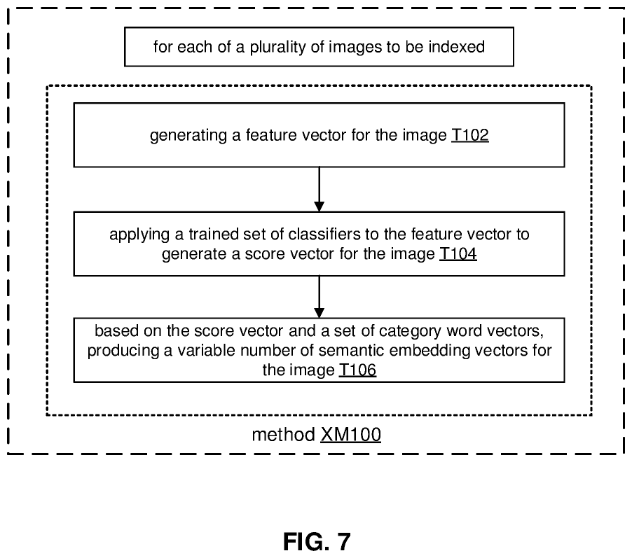

FIG. 7 shows a flowchart of an image indexing method XM100 according to a general configuration that includes performing each of tasks T102, T104, and T106 for each of a plurality of images to be indexed. Task T102 generates a feature vector for the image (e.g., as described herein with reference to trained CNN TN100). Task T104 applies a trained set of classifiers to the feature vector to generate a score vector for the image (e.g., as described herein with reference to predictor P100). Based on the score vector and a set of category word vectors, task T106 produces a variable number of semantic embedding vectors for the image (e.g., as described herein with reference to indexer IX100).

At an offline stage, method XM100 may be performed to index all of the photos in a user's photo album via the learned visual-semantic-embedding. When a new image arrives, for example, method XM100 may first compute its deep feature using the visual model and then transform it to an embedding mixture via the learned network.

A device for capturing and viewing photos (e.g., a smartphone) may be configured to perform or initiate indexing method XM100 in several different ways. In one example, indexing method XM100 may be performed when the photo is taken, or when the photo is uploaded to cloud storage (i.e., on-the-fly). In another example, the captured or uploaded photos are stored in a queue, and indexing method XM100 may be launched as a batch process on the queue upon some event or condition (e.g., when the phone is in charging mode).

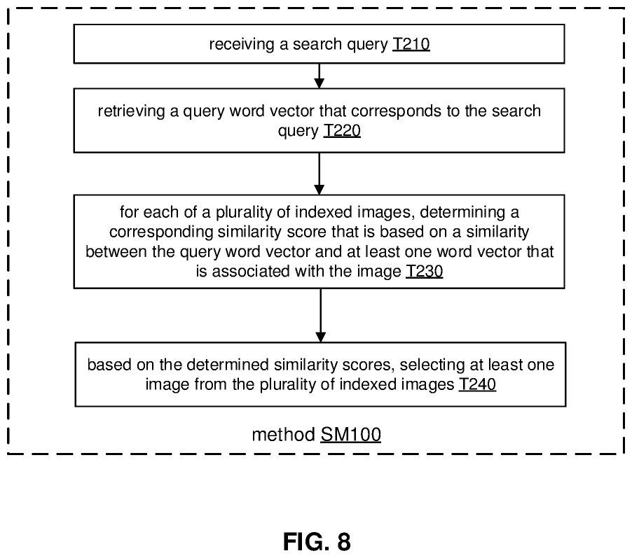

In a searching mode, when a text query arrives, it may be desirable for the system to compute a word vector corresponding to the query and to determine the nearest indexed images in the embedding space. FIG. 8 shows a flowchart for a query searching method SM100 according to a general configuration that includes tasks T210, T220, T230, and T240. Task T210 receives a search query (e.g., by text entry, by speech recognition, etc.). Task T220 retrieves a query word vector that corresponds to the search query (e.g., from a semantic embedding space as described herein). For each of a plurality of indexed images, task T230 determines a corresponding similarity score that is based on a similarity between the query word vector and at least one word vector that is associated with the image (e.g., one or more of the variable number of semantic embedding vectors as described herein). In one example, a similarity score sim(query, I) between a text query and an image I is calculated based on cosine similarity as follows:

sim(query, I)=argmaxᵢ cos(s(query), embᵢ(I)).

Based on the determined similarity scores, task T240 selects at least one image from the plurality of indexed images. For example, the image or images having the highest similarity scores may be returned to the user as the top-ranked search result photos. A portable device configured to perform method SM100 (e.g., a smartphone) may be implemented to convert the search query to a word vector locally (which may require a large storage capacity) or to send the search query to the cloud for conversion.

Indexing and search techniques as described herein may be used to provide several novel search modes to enrich the user experience. The mapping of a large query vocabulary into a visual-semantic space may permit a user to search freely, using any of a large number of query terms, rather than just a small predefined set of keywords that correspond exactly to preexisting image tags. Such a technique may be implemented to allow for a semantic search mode in which different synonyms as queries (e.g., ‘car’, ‘vehicle’, ‘automobile’, or even ‘Toyota’) lead to a stable and similar search result (i.e., car-related images are returned). Such a technique may also be implemented to support a novel ‘exploration mode’ for photo album searching, in which semantically related concepts are retrieved for a fuzzy search result. In one example, operation in ‘exploration mode’ returns an image of a piggy bank as the best match in response to the query term ‘deposit.’ In another example, images of the sky, of an airplane, and of a bird are returned as the best matches in response to the query term ‘fly.’

In one example, system XS100 is implemented as a device that comprises a memory and one or more processors. The memory is configured to store the image to be indexed, and the one or more processors are configured to generate a corresponding feature vector for the image (e.g., to perform the operations of trained CNN TN100 as described herein), to apply a trained set of classifiers to the feature vector to generate a score vector for the image (e.g., to perform the operations of predictor P100 as described herein), and to produce a variable number of semantic embedding vectors for the image based on the score vector (e.g., to perform the operations of indexer IX100 as described herein). In one example, the device is a portable device, such as a smartphone. In another example, the device is a cloud computing unit (e.g., a server in communication with a smartphone, where the smartphone is configured to capture and provide the images to be indexed).

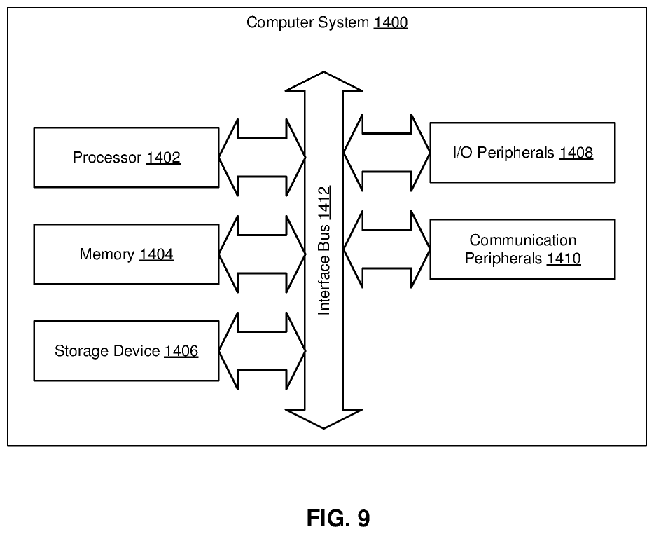

FIG. 9 illustrates examples of components of a computer system 1400 that may be an implementation of a system as described herein (e.g., system XS100 or TS100) and/or may be configured to perform an implementation of a method as described herein (e.g., method XM100 and/or method SM100). Although these components are illustrated as belonging to a same computer system 1400, computer system 1400 may also be implemented such that the components are distributed (e.g., among different servers, among a smartphone and one or more network entities, etc.).

The computer system 1400 includes at least a processor 1402, a memory 1404, a storage device 1406, input/output peripherals (I/O) 1408, communication peripherals 1410, and an interface bus 1412. The interface bus 1412 is configured to communicate, transmit, and transfer data, controls, and commands among the various components of the computer system 1400. The memory 1404 and the storage device 1406 include computer-readable storage media, such as RAM, ROM, electrically erasable programmable read-only memory (EEPROM), hard drives, CD-ROMs, optical storage devices, magnetic storage devices, electronic non-volatile computer storage, for example Flash® memory, and other tangible storage media. Any of such computer readable storage media can be configured to store instructions or program codes embodying aspects of the disclosure. The memory 1404 and the storage device 1406 also include computer readable signal media. A computer readable signal medium includes a propagated data signal with computer readable program code embodied therein. Such a propagated signal takes any of a variety of forms including, but not limited to, electromagnetic, optical, or any combination thereof. A computer readable signal medium includes any computer readable medium that is not a computer readable storage medium and that can communicate, propagate, or transport a program for use in connection with the computer system 1400.

Further, the memory 1404 includes an operating system, programs, and applications. The processor 1402 is configured to execute the stored instructions and includes, for example, a logical processing unit, a microprocessor, a digital signal processor, and other processors. The memory 1404 and/or the processor 1402 can be virtualized and can be hosted within another computer system of, for example, a cloud network or a data center. The I/O peripherals 1408 include user interfaces, such as a keyboard, screen (e.g., a touch screen), microphone, speaker, other input/output devices (e.g., a camera configured to capture the images to be indexed), and computing components, such as graphical processing units, serial ports, parallel ports, universal serial buses, and other input/output peripherals. The I/O peripherals 1408 are connected to the processor 1402 through any of the ports coupled to the interface bus 1412. The communication peripherals 1410 are configured to facilitate communication between the computer system 1400 and other computing devices (e.g., cloud computing entities configured to perform portions of indexing and/or query searching methods as described herein) over a communications network and include, for example, a network interface controller, modem, wireless and wired interface cards, antenna, and other communication peripherals.

While the present subject matter has been described in detail with respect to specific embodiments thereof, it will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations, and/or additions to the present subject matter as would be readily apparent to one of ordinary skill in the art. Indeed, the methods and systems described herein may be embodied in a variety of other forms; furthermore, various omissions, substitutions and changes in the form of the methods and systems described herein may be made without departing from the spirit of the present disclosure. The accompanying claims and their equivalents are intended to cover such forms or modifications as would fall within the scope and spirit of the present disclosure.

Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

The system or systems discussed herein are not limited to any particular hardware architecture or configuration. A computing device can include any suitable arrangement of components that provide a result conditioned on one or more inputs. Suitable computing devices include multipurpose microprocessor-based computer systems accessing stored software that programs or configures the computer system from a general-purpose computing apparatus to a specialized computing apparatus implementing one or more embodiments of the present subject matter. Any suitable programming, scripting, or other type of language or combinations of languages may be used to implement the teachings contained herein in software to be used in programming or configuring a computing device.

Embodiments of the methods disclosed herein may be performed in the operation of such computing devices. The order of the blocks presented in the examples above can be varied—for example, blocks can be re-ordered, combined, and/or broken into sub-blocks. Certain blocks or processes can be performed in parallel.

The terms “including,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. The use of “adapted to” or “configured to” herein is meant as open and inclusive language that does not foreclose devices adapted to or configured to perform additional tasks or steps. Unless indicated otherwise, the phrase “A is based on B” includes the case in which A is equal to B. Additionally, the use of “based on” is meant to be open and inclusive, in that a process, step, calculation, or other action “based on” one or more recited conditions or values may, in practice, be based on additional conditions or values beyond those recited. Similarly, the use of “based at least in part on” is meant to be open and inclusive, in that a process, step, calculation, or other action “based at least in part on” one or more recited conditions or values may, in practice, be based on additional conditions or values beyond those recited. Headings, lists, and numbering included herein are for ease of explanation only and are not meant to be limiting.

The various features and processes described above may be used independently of one another, or may be combined in various ways. All possible combinations and sub-combinations are intended to fall within the scope of the present disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed examples. Similarly, the example systems and components described herein may be configured differently than described. For example, elements may be added to, removed from, or rearranged compared to the disclosed examples.

What is claimed is:

1. A method of indexing a plurality of images, the method comprising:
for each of the plurality of images:
generating a feature vector for the image;
applying a trained set of classifiers to the feature vector to generate a score vector for the image; and
based on the score vector and a set of category word vectors, producing a variable number of semantic embedding vectors for the image.

2. The method of claim 1, wherein, for each of the plurality of images, each of the variable number of semantic embedding vectors corresponds to a different category word vector of the set of category word vectors.

3. The method of claim 1, wherein, for each of the plurality of images, the value of the variable number is based on a relation between a threshold value and elements of the score vector.

4. The method of claim 1, wherein, for each of the plurality of images, the score vector indicates, for each among the set of category word vectors, a probability that a corresponding label appears in the image.

5. The method of claim 1, wherein the trained set of classifiers is based on a co-occurrence of labels among the tags for each of a set of training images.

6. The method of claim 1, wherein the method further comprises, for each of the plurality of images, adding to a group of entries for indexed images an entry for the image that identifies the semantic embedding vectors of the variable number of semantic embedding vectors.

7. The method of claim 1, wherein the method comprises, for each of the plurality of images, receiving the image from a camera of a smartphone.

8. An image indexing system comprising:
a trained neural network configured to generate a feature vector for an image to be indexed;
a predictor configured to apply a trained set of classifiers to the feature vector to generate a score vector for the image; and
an indexer configured to produce a variable number of semantic embedding vectors for the image, based on the score vector and a set of category word vectors.

9. The system of claim 8, wherein, for each of the plurality of images, each of the variable number of semantic embedding vectors corresponds to a different category word vector of the set of category word vectors.

10. The system of claim 8, wherein, for each of the plurality of images, the value of the variable number is based on a relation between a threshold value and elements of the score vector.

11. The system of claim 8, wherein, for each of the plurality of images, the score vector indicates, for each among the set of category word vectors, a probability that a corresponding label appears in the image.

12. The system of claim 8, wherein the trained set of classifiers is based on a co-occurrence of labels among the tags for each of a set of training images.

13. The system of claim 8, wherein the system further comprises an index configured to store, for each of a plurality of images that have been indexed, an entry that identifies the semantic embedding vectors of the corresponding variable number of semantic embedding vectors.

14. The system of claim 8, wherein the system includes a camera configured to capture the image to be indexed.

15. A non-transitory computer-readable storage medium storing computer-executable instructions, which when executed by one or more processors, cause the one or more processors to execute a method of indexing a plurality of images, the method comprising:
for each of the plurality of images:
generating a feature vector for the image;
applying a trained set of classifiers to the feature vector to generate a score vector for the image; and
based on the score vector and a set of category word vectors, producing a variable number of semantic embedding vectors for the image.

16. The non-transitory computer-readable storage medium of claim 15, wherein, for each of the plurality of images, each of the variable number of semantic embedding vectors corresponds to a different category word vector of the set of category word vectors.

17. The non-transitory computer-readable storage medium of claim 15, wherein, for each of the plurality of images, the value of the variable number is based on a relation between a threshold value and elements of the score vector.

18. The non-transitory computer-readable storage medium of claim 15, wherein, for each of the plurality of images, the score vector indicates, for each among the set of category word vectors, a probability that a corresponding label appears in the image.

19. The non-transitory computer-readable storage medium of claim 15, wherein the trained set of classifiers is based on a co-occurrence of labels among the tags for each of a set of training images.

20. The non-transitory computer-readable storage medium of claim 15, wherein the method further comprises: for each of the plurality of images, adding to a group of entries for indexed images an entry for the image that identifies the semantic embedding vectors of the variable number of semantic embedding vectors.
